(19) United States
(12) Patent Application Publication
(10) Pub. No.: US 2026/0001284 A1
(43) Pub. Date: Jan. 1, 2026

(54) VARIABLE SIZE HIGH SPEED WELDER

(71) Applicant: Erdman Automation Corporation, Princeton, MN (US)

(72) Inventors: Morgan W. Donohue, North Oaks, MN (US); Andrew D. Peterson, Zimmerman, MN (US); Peter J. Kroll, Saint Stephen, MN (US)

(21) Appl. No.: 18/760,804

(22) Filed: Jul. 1, 2024

(51) Int. Cl. B29C 65/00; B25B 5/14; B29C 65/02; B29L 31/00

(52) U.S. Cl. CPC B29C 66/8412; B25B 5/145; B29C 65/02; B29C 66/52431; B29L 2031/005

(57) ABSTRACT

A variable size welder that facilitates welding of polymer quadrilateral frame structures. The welder includes at least two parts conveyors that deliver parts from a remote location and parts staging stations and end heaters on each of four sides of the variable size welder. A centrally located four corner clamping structure and at least two robotic parts movers are configured to reach the at least two parts conveyors and also to reach the parts staging stations and end heaters. The at least two robotic parts movers are further configured to reach at least a portion of the four corner clamping structure.

### CLAIM TO PRIORITY

This application claims the benefit of U.S. Provisional Patent Application Ser. No. 63/525,063 entitled “Variable Size High Speed Welder”, filed on Jul. 5, 2023, the entire content of which is incorporated herein by reference.

### TECHNICAL FIELD

The invention is related to manufacturing windows, window frames, sashes and insulated glass units.

### BACKGROUND

Every insulated glass unit that is produced is eventually mated to some kind of sash before it can be used in construction.

With currently available automated manufacturing equipment it is possible to manufacture an insulated glass unit in 16 to 20 seconds. However, manufacturing a sash to mate with an insulated glass unit typically takes at least 3 to 4 times as long. This mismatch in manufacturing time can be addressed in a number of ways.

In some circumstances, multiple sash manufacturing machines are utilized to provide sashes to a single insulated glass unit manufacturing machine so that each insulated grass unit can be mated with a sash to complete a window. Another option is to manufacture sashes in batches and then to store a quantity of sashes of various sizes in a warehouse environment to provide to a single insulated glass manufacturing unit.

Utilizing multiple sash welding machines often requires an extensive amount of floor space in a manufacturing environment as well as a large number of employees or operators to operate the machinery. For example, using four conventional frame welders to prepare sashes for a high-speed parallel process insulated glass unit line may require about 16,000 square feet of floor space for machinery to manufacture approximately 1,200 sashes over an eight hour shift.

In an additional example, operation of the four conventional frame welders and related manufacturing equipment to prepare sashes requires the attention of approximately twenty-one employee operators.

The large quantity of machinery also requires considerable maintenance and creates a large amount of work in progress that must be stored, transported and tracked during production.

Another issue that arises in the manufacturing of windows is that windows for residential use are often ordered in a batch to accommodate the construction of a single residence. The required windows are generally ordered in a batch for a particular house. Of course, houses generally vary in the size, shape and number of windows in each residence.

Typically, a house may have three to five or more different sizes of windows that are to be installed. For order filling and shipping purposes it is difficult to manufacture the batch of windows in an order for a home for shipping together.

Insulated glass units and windows are often manufactured in runs of a significant number of windows all the same size. These windows must be stored or warehoused to accommodate orders for various sizes. Then, the stored windows must be retrieved from storage and the various size windows grouped together for shipping to construction projects. This can be time and labor intensive.

### SUMMARY

Example embodiments of the invention assist in solving many of the above discussed problems. The variable size high-speed welder as disclosed facilitates manufacturing of sashes and frames at a speed commensurate with the manufacturing of insulated glass units with which the sashes will be mated. Example embodiments also facilitate manufacturing of windows in variable sizes, for example, the several sizes required for the building of a home, one after another and grouping them together for shipment.

A variable size high-speed welder according to an example embodiment of the invention generally includes two parts conveyors, four robotic parts movers, two parts staging and end-heating stations on each of four sides for a total of eight part-staging and end-heating stations. A centrally located four corner clamping structure and a finished frame removal robotic structure.

In an example embodiment depicted in the FIG., two conveyors are located proximate adjacent sides of the structure of the welder assembly. The conveyors are loaded with frame parts in an alternating pattern. For example, if a sash is being manufactured, parts might be loaded in the sequence stile, rail, stile, rail and so on. If a window frame is being manufactured parts might be loaded in the sequence jamb, sill, jamb, sill or jamb, header, jamb, header and so on. The conveyors are oriented so that an operator can access ends of the conveyors that are proximate the operator to load parts while remaining well clear of the robots that remove parts from the conveyors and transfer them at a distal end of the conveyors. This enhances both operator efficiency and safety.

The welding assembly is a generally quadrilateral structure.

Each side of the quadrilateral structure presents two part-staging and end-heating stations. These include an internal station and an external station. Each of these stations is structured to receive parts and to heat mitered ends thereof to melt the polymers that the parts are made of.

Each end heater includes two heat plates that are angled at, for example, 45 degrees to a long axis of the part. The heat plates of each station are movable so that a distance separating them can be varied as desired to match a length of the part being processed. The heat plates are capable of producing heat sufficient to render ends of the parts molten in a few seconds to prepare parts to be fused.

At least two robots, for example four robots, are located, for example at opposite corners of the welding assembly. In an example embodiment four robots are present, one at each corner of the welding assembly. The robots are each configured to perform at least two actions. First, the robots remove parts from the conveyors and transfer them to the part staging and end heaters. Second, the robots move parts, the ends of which have been rendered at least partially molten, from the part staging and end heaters to the four-corner clamping structure to be abutted with and joined by fusion to other parts to form a completed sash or frame. According to an example embodiment, the robots utilized are SCARA (Selective Compliance Assembly Robot Arm) robots. Other robots having sufficient mobility and reach can be utilized as well.

The two or four robots can be synchronized and coordinated to all move simultaneously to avoid conflicting motion. For example, all the robots may move to the right or to the left simultaneously.

According to an example embodiment, the four-corner clamping structure includes four “L” shaped corner clamps that can be located on two movable beams. Two of the corner clamps are located on each beam and are moveable along the length of the beam which is itself movable orthogonal to its long axis thus enabling the four-corner clamping structure to accept and clamp any size sash or frame that is between the maximum and minimum size to be accommodated. In an example embodiment, the four corner clamps are moved about a center point so that sashes or frames that are made are always centered in the welding assembly upon completion. The four corner clamps are configured to apply force to the at least partially molten ends of the parts being joined for a sufficient time for the ends to fuse.

According to an example embodiment, a finished frame removal robotic structure is positionable to reach downwardly to grasp the finished sash or frame and lift the finished sash or frame upwardly and then to transport the finished sash or frame to a nearby location to be mated with an insulated glass unit thus forming an at least partially completed insulated glass window. In an example embodiment, the finished frame removal robotic structure can be a SCARA robot similar to the other four robots.

In operation, an operator places parts to be assembled and welded, alternating the parts as discussed above. Each robot operates under computer control to remove a first part or a second part from one of the conveyors and transfer the part to an appropriately chosen one of the internal or external staging and heating stations. For example, the four external staging and heating stations. While the parts are at the staging and heating stations the heating plates are moved under computer control to contact ends of the parts that are to be joined to other of the parts to form the sash or frame. This occurs simultaneously for each of the four parts to be joined. Meanwhile, the robots are transferring parts from the conveyors to the staging and heating station not occupied by parts to be joined, for example the internal staging and heating stations. Once the ends of parts are at least partially molten, each of the robots grasps one of the four parts and transfers the four parts to the four-corner clamping structure. The four-corner clamping structure adapts to a desired size to receive the parts. The parts are inserted into the four-corner clamping structure and the corner clamps move under computer control to clamp the parts together. The parts are held clamped for an appropriate amount of time for the at least partially molten ends to fuse and cool to a non-molten state thus converting the four parts to a at least partially finished sash or frame. This is typically a matter of seconds.

The finished frame removal structure then descends from above under computer control or reaches over the variable speed high speed welder from an adjacent location and grasps the at least partially finished sash or frame and removes it from the four-corner clamping structure substantially vertically and then transports it horizontally to another location to be joined to an insulated glass unit to be joined to be a completed glazed sash structure.

It is expected that the invention will be able to produce approximately 1,200 welded sashes or frames per each eight-hour shift and achieve a cycle time per unit of approximately twenty seconds per produced unit. At the same time the invention is expected to occupy between approximately 6,500 and 8,000 square feet of floor space which amounts to a savings of fifty percent or more over the conventional approach described above. Further, it is expected that the invention will reduce the number of employees/operators per shift required to produce the 1,200 welded sashes or frames by about twenty. Further, by reducing the number of machines required it is expected that maintenance needs will be reduced as well. It is further expected that scheduling efficiency will be improved because variable sizes of sashes and frames can be made to coordinate with the various sizes needed to be produced for orders typically made for each individual residential construction project. It is expected that work in progress will be reduced with consequent improvements in the production of finished window units. Power requirements are reduced when less machinery is operated. Lastly, parts distribution to a single manufacturing location is simpler than distribution to four or more locations.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a variable size high speed welder according to an example embodiment of the invention;

FIG. 2 is a plan view of a variable size high speed welder according to an example embodiment of the invention;

FIG. 3 is a perspective view of a variable size high speed welder according to an example embodiment of the invention; and

FIG. 4 is a flow chart depicting a method according to an example embodiment of the invention.

### DETAILED DESCRIPTION

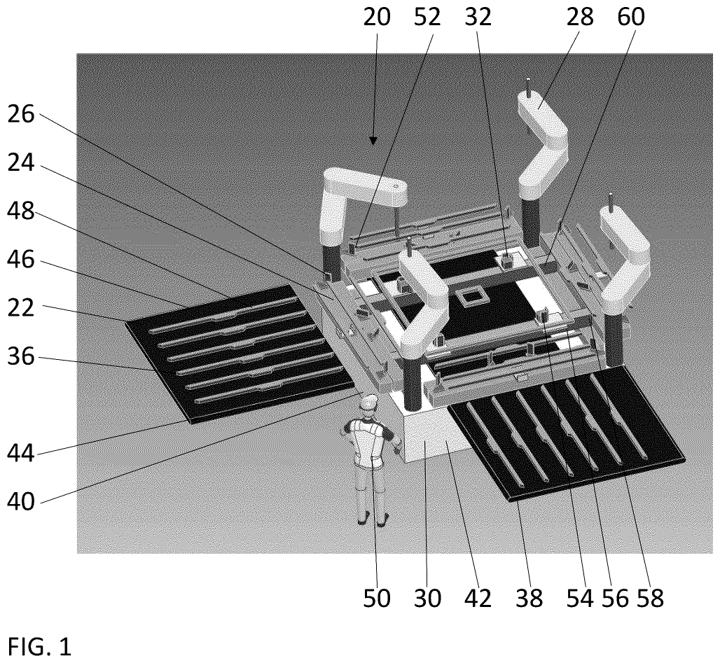

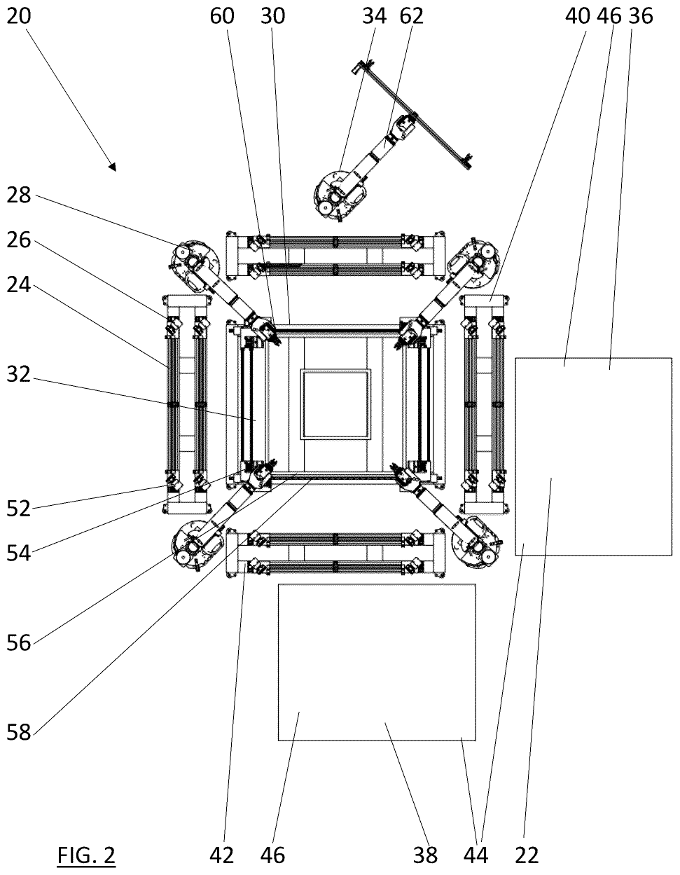

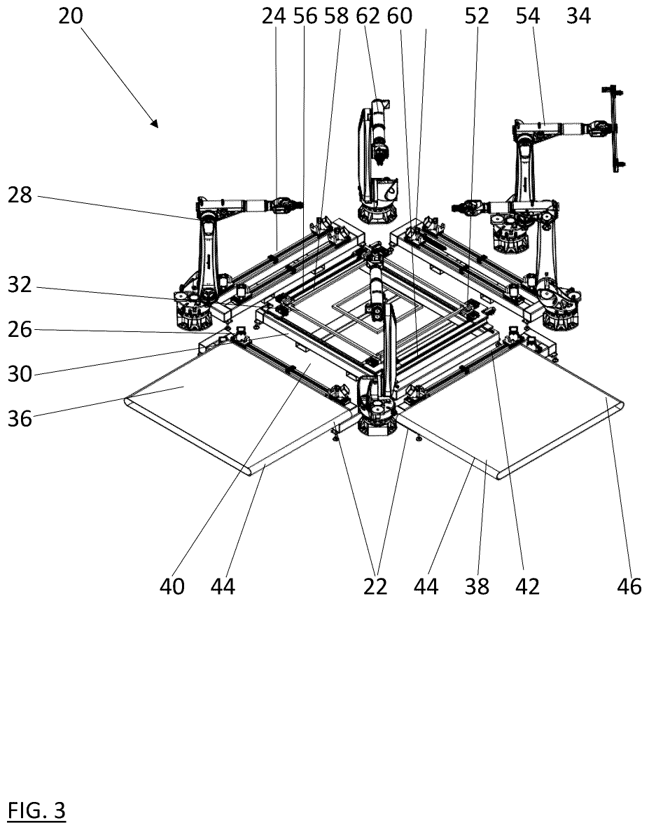

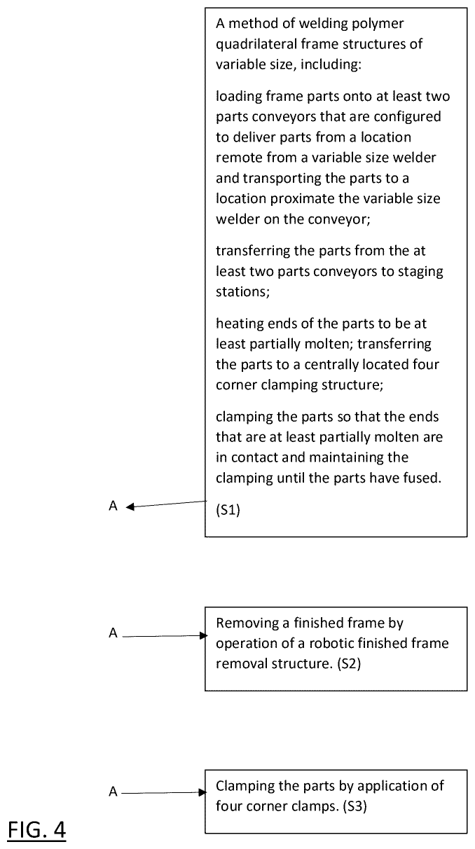

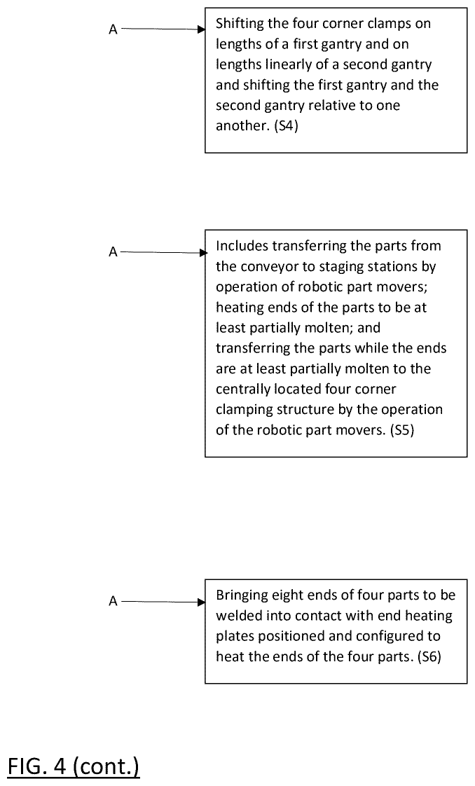

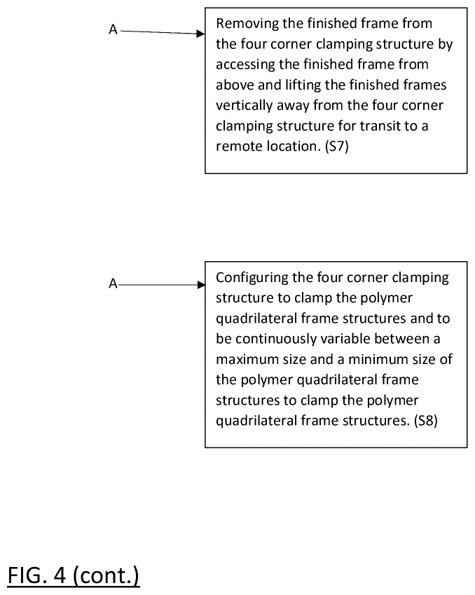

Referring to for example to FIGS. 1, 2 and 3, variable size high-speed welder 20, according to an example embodiment, generally includes parts conveyors 22, staging stations 24, end heaters 26, parts handling robots 28, quadrilateral base 30, corner clamping structure 32 and finished frame remover 34.

Parts conveyors 22 generally include first conveyor 36 and second conveyor 38. In the depicted example embodiment, first conveyor 36 and second conveyor 38 are located on two adjacent sides of quadrilateral base 30. First conveyor 36 and second conveyor 38 are structured and oriented to move parts generally parallel to first side 40 and second side 42 of quadrilateral base 30. For example, first conveyor 36 and second conveyor 38 are arranged to transport parts away from proximal ends 44 toward distal ends 46 so that parts 48 placed on conveyors 22 by operator 50 are moved away from operator 50.

Staging stations 24 are located on at least first side 40 and second side 42 of quadrilateral base 30. According to an example embodiment depicted in FIG. 1, staging stations 24 are located on four sides of quadrilateral base 30.

End heaters 26 are positioned adjacent to and associated with each of staging stations 24 and similarly may be positioned on at least first side 40 and second side 42 of quadrilateral base 30. It is helpful but not required if end heaters 26 are located inwardly of staging stations 24 and on all 4 sides of quadrilateral base 30.

End heaters 26 include heat plates 52. Heat plates 52 are adjustable in separation so that a distance separating them is variable as desired to facilitate a length of a particular part 48 or parts 48 being processed and heated at ends thereof. Heat plates 52 may be one sided. According to another example embodiment, heat plates 52 may be two-sided, having two planar sides for example. In either case, heat plates 52 are structured to supply heat sufficient to render ends of parts 48 at least partially molten within a few seconds of contact. According to an example embodiment, heat plates 52 are electrically heated by integrally embedded electrical heating elements. Heat plates 52 may be coated or covered with a heat resistant nonstick material on both sides. It is notable that heat plates 52 are located approximately at four corners of a quadrilateral and whether one sided or two sided are adjustable in position so as to facilitate heating of eight ends of four frame parts simultaneously. In addition, according to a further example embodiment, a total of eight heat plates 52 may be associated with each set of staging stations 24 and end heaters 26. This then allows a first set of frame parts 48 to be joined and fused while a second set of frame parts 48 is being prepared to be joined and fused by end heating.

Parts handling robots 26 are located proximate corners of quadrilateral base 30. Parts handling robots 26 may be present in a number of at least two or four parts handling robots 26. Parts handling robots 26 have sufficient reach to access parts 48 on parts conveyors 22 and also to place parts 48 in corner clamping structure 32 whether corner clamping structure 32 is at its maximum size or minimum size as well as any size in between maximum size and minimum size. Parts handling robots 28 may include robots having two vertically oriented axes of rotation as well as a downwardly reaching member which is rotatable about a vertical axis as well for example.

Parts handling robots 26 can include SCARA robots. Parts handling robots 26 are each configured to perform at least two actions. First, parts handling robots 26 remove parts 48 from parts conveyors 22 and transfer parts 48 to staging stations 24 and proximate end heaters 26. Second, parts handling robots 28 move parts from staging stations 24 and end heaters 26 to corner clamping structure 32.

Parts handling robots 28 can be synchronized and coordinated to move simultaneously while avoiding conflicting motion. For example, parts handling robots 28 may be configured to move to the right or to the left simultaneously.

Corner clamping structure 32 generally includes four L-shaped corner clamps 54. Corner clamps 54 are positioned, for example, on two movable beams 56. Two corner clamps 54 are positioned on first movable beam 58 and two corner clamps are positioned on second movable beam 60. Corner clamps 54 are movable along a length of each movable beam 56. First movable beam 58 and second movable beam 60 are each movable for example orthogonal to a long axis thereof. In an example embodiment, four corner clamps 54 are movable about a center point so that all four corner clamps 54 are consistently generally equidistant from a center point.

Finished frame remover 34 generally includes frame removal robot 62 which reaches down from above to grasp and remove the finished frame and move it to a location for further processing. Frame removal robot 62 may be located adjacent to welder 20 or may be suspended from a ceiling above welder 20 according to example embodiments. Frame removal robot 62 may include a SCARA robot, for example.

According to an example embodiment, the invention includes a method of welding polymer quadrilateral frame structures of variable size, including: loading frame parts onto at least two parts conveyors that are configured to deliver parts from a location remote from a variable size welder and transporting the parts to a location proximate the variable size welder on the conveyor; transferring the parts from the at least two parts conveyors to staging stations; heating ends of the parts to be at least partially molten; transferring the parts to a centrally located four corner clamping structure; clamping the parts so that the ends that are at least partially molten are in contact and maintaining the clamping until the parts have fused. (S1)

According to an example embodiment the method further includes removing a finished frame by operation of a robotic finished frame removal structure. (S2)

According to an example embodiment the method further includes clamping the parts by application of four corner clamps. (S3)

According to an example embodiment the method further includes shifting the four corner clamps on lengths of a first gantry and on lengths linearly of a second gantry and shifting the first gantry and the second gantry relative to one another. (S4)

According to an example embodiment the method further includes transferring the parts from the conveyor to staging stations by operation of robotic part movers; heating ends of the parts to be at least partially molten; and transferring the parts while the ends are at least partially molten to the centrally located four corner clamping structure by the operation of the robotic part movers. (S5)

According to an example embodiment the method further includes bringing eight ends of four parts to be welded into contact with end heating plates positioned and configured to heat the ends of the four parts. (S6)

According to an example embodiment the method further includes removing the finished frame from the four corner clamping structure by accessing the finished frame from above and lifting the finished frames vertically away from the four corner clamping structure for transit to a remote location. (S7)

According to an example embodiment the method further includes configuring the four corner clamping structure to clamp the polymer quadrilateral frame structures and to be continuously variable between a maximum size and a minimum size of the polymer quadrilateral frame structures to clamp the polymer quadrilateral frame structures. (S8)

In operation, operator 50 loads parts 48 onto proximal ends 44 of first conveyor 36 and second conveyor 38. Parts 48 may be loaded alternately, for example stile rail, stile, rail.

Parts conveyors 22 then convey parts 48 to distal ends 46 of first conveyor 36 and second conveyor 38.

Parts handling robots 28 then access and lift parts 48 from distal end 46 of parts conveyors 22 and transport parts 48 to staging stations 24. Parts handling robots 28 are, for example, programmed to deliver parts to inner staging stations 24 and outer staging stations 24 alternately.

Parts 48 are then brought into contact with heat plates 52. According to an example embodiment of the invention, eight distal ends 46 of four parts 48 are simultaneously brought into contact with former heat plates 52 distal ends 46 of adjacent parts 48 are brought into contact with opposing sides of the plates 52 thus allowing simultaneous heating of all eight distal ends 46 of four parts 48 until the polymer at distal ends 46 is at least partially molten. Parts handling robots 28 then each grip one of parts 48 and transport parts 48 to corner clamping structure 32. Corner clamps 54 of corner clamping structure 32 are programmed to be set slightly larger than the parts to be joined and the size of the frame to be made and are then moved inwardly in concert to clamp at least partially molten distal ends 46 of parts 48 together and to hold distal ends 46 of parts 48 together until the partially molten polymer cools, solidifies and fuses the four parts into a completed four sided frame. Corner clamping structure 32 then releases corner clamps 54 and finished frame remover 34 removes the finished frame from clamping corner clamping structure 32. For example, frame removal robot 62 reaches down from above and grasps the finished frame, removes it from the center of the corner clamping structure 32 and transports it to another location for further processing.

Corner clamping structure 32 is continuously variable in spacing between corner clamps 54 thus permitting the assembly and processing of multiple sizes of parts 48 to create many different sizes of window frames. This feature facilitates the welding and preparation of multiple size sashes or window frames in any order. This further facilitates the processing of the several different size windows to be utilized in construction of a single home in sequence so that all of the windows for a home construction project may be produced as a group thus facilitating packaging and shipping of the windows for a home construction project.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims in a related utility application.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

1. A variable size welder that facilitates welding of polymer quadrilateral frame structures, comprising:
at least two parts conveyors configured to deliver parts from a location remote from the variable size welder;
parts staging stations and end heaters on each of four sides of the variable size welder;
a centrally located four corner clamping structure; and
at least two robotic parts movers configured to reach the at least two parts conveyors and also to reach the parts staging stations and end heaters;
wherein the at least two robotic parts movers are further configured to reach at least a portion of the four corner clamping structure.

2. The variable size welder as claimed in claim 1, further comprising a finished frame removal robotic structure.

3. The variable size welder as claimed in claim 1, wherein the centrally located four corner clamping structure further comprises four moveable corner clamps.

4. The variable size welder as claimed in claim 3, wherein the four corner clamps are located on a first gantry and on a second gantry and are shiftable linearly along lengths of the first gantry and the second gantry and wherein the first gantry and the second gantry are shiftable relative to one another.

5. The variable size welder as claimed in claim 1, wherein the four parts staging stations and end heaters on each of four sides of the variable size welder each comprise a parts staging position and two end heating plates.

6. The variable size welder as claimed in claim 5, wherein the end heaters include the heating plates positioned and configured to heat eight ends of four parts to be welded.

7. The variable size welder as claimed in claim 2, wherein the finished frame removal robotic structure is located at least partially above the four corner clamping structure and lifts finished frames vertically away from the four corner clamping structure for transit to a remote location.

8. The variable size welder as claimed in claim 1, wherein the four corner clamping structure is configured to clamp the polymer quadrilateral frame structures and is continuously variable to clamp the polymer quadrilateral frame structures between a selected maximum size and a selected minimum size of the polymer quadrilateral frame structures.

9. A method of welding of polymer quadrilateral frame structures of variable size, comprising:
loading frame parts onto at least two parts conveyors that are configured to deliver parts from a location remote from a variable size welder and transporting the parts to a location proximate the variable size welder on the conveyor;
transferring the parts from the at least two parts conveyors to staging stations;
heating ends of the parts to be at least partially molten;
transferring the parts to a centrally located four corner clamping structure;
clamping the parts so that the ends that are at least partially molten are in contact and maintaining the clamping until the parts have fused.

10. The method as claimed in claim 9, further comprising removing a finished frame by operation of a robotic finished frame removal structure.

11. The method as claimed in claim 9, further comprising clamping the parts by application of four corner clamps.

12. The method as claimed in claim 11, further comprising linearly shifting the four corner clamps on lengths of a first gantry and on lengths of a second gantry and shifting the first gantry and the second gantry relative to one another.

13. The method as claimed in claim 9, further comprising:
transferring the parts from the conveyor to staging stations by operation of robotic part movers;
heating ends of the parts to be at least partially molten;
transferring the parts while the ends are at least partially molten to the centrally located four corner clamping structure by the operation of the robotic part movers.

14. The method as claimed in claim 13, further comprising bringing eight ends of four parts to be welded into contact with four end heating plates positioned and configured to heat the ends of the four parts.

15. The method as claimed in claim 10, further comprising removing the finished frame from the four corner clamping structure by accessing the finished frame from above and lifting the finished frames vertically away from the four corner clamping structure for transit to a remote location.

16. The method as claimed in claim 9, further comprising configuring the four corner clamping structure to clamp the polymer quadrilateral frame structures and to be continuously variable between a maximum size and a minimum size of the polymer quadrilateral frame structures to clamp the polymer quadrilateral frame structures.

17. A variable size welder that facilitates welding of polymer quadrilateral frame structures, comprising:
two parts conveyors configured to deliver parts from a location remote from the variable size welder;
four parts staging stations and end heaters located on each of four sides of the variable size welder;
a centrally located four corner clamping structure; and
four robotic parts movers each configured to reach the at least two parts conveyors and also to reach the at least one of the four parts staging stations;
wherein the at least two robotic parts movers are further configured to reach at least a portion of the four corner clamping structure and to place parts received from the two parts conveyors at one of the four parts staging stations and then to transfer the parts to the four corner clamping structure.

18. The variable size welder as claimed in claim 17, further comprising a finished frame removal robotic structure and wherein the finished frame removal robotic structure is located at least partially above the four corner clamping structure and lifts finished frames vertically away from the four corner clamping structure for transit to a remote location; or
wherein the four end heaters share four end heating plates positioned and configured to heat eight ends of four parts to be welded.

19. The variable size welder as claimed in claim 17, wherein the centrally located four corner clamping structure further comprises four moveable corner clamps; and wherein the four corner clamps are located on a first gantry and a second gantry and are shiftable linearly along lengths of the first gantry and the second gantry and wherein the first gantry and the second gantry are shiftable relative to one another.

20. The variable size welder as claimed in claim 17, wherein the four corner clamping structure is configured to clamp the polymer quadrilateral frame structures and is continuously variable to clamp the polymer quadrilateral frame structures between a selected maximum size and a selected minimum size of the polymer quadrilateral frame structures.
